(19) United States
(12) Patent Application Publication
(10) Pub. No.: US 2003/0117633 A1
(43) Pub. Date: Jun. 26, 2003

(54) Probe with a diffraction grating for +1,0 and -1 orders

(76) Inventors: Markus Rudolph, Northeim (DE); Bernd Gusek, Rosdorf (DE)

Correspondence Address: VENABLE, BAETJER, HOWARD AND CIVILETTI, LLP, P.O. BOX 34385, WASHINGTON, DC, 20043-9998, US

(21) Appl. No.: 10/296,394

(22) PCT Filed: May 18, 2001
(86) PCT No.: PCT/DE01/01871

(30) Foreign Application Priority Data
May 23, 2000 (DE) 100 25 461.6

(51) Int. Cl. G01B 9/02; G01B 11/02

(52) U.S. Cl. 356/521; 356/511

(57) ABSTRACT

A measuring device that employs interference optics for detecting and tracking the movement of a mechanical element (4) has a light source (31) for emitting a light bundle that is capable of interference, a diffraction grating and a sensor arrangement (33). A beam path leads from the light source to the sensor arrangement (33) by way of the diffraction grating (32). The diffraction grating divides the light bundle into at least three partial components, thereby forming a light patch having three overlapping maxima, the center, zero maximum and the two minus one and plus one maxima on either side, at the optical sensor arrangement (33). The light beams for generating the three brightness maxima interfere with one another, so the resulting superposed light patch (46) contains interference bands that run in one direction or another when the diffraction grating is moved. The movement of the interference bands is detected with the sensor arrangement (33), and evaluated in an evaluation circuit. This permits a precise detection of each movement of the diffraction grating (32). The proposed arrangement utilizes virtually the entire interference pattern generated from the light emitted by the light source. This results in light-intensive interference patterns, even with low capacities of the light source (31). Thus, low-capacity components can be used.

The invention relates to a measuring device that is provided particularly for measuring the surface roughness and/or the surface contour of a workpiece.

For measuring workpieces and determining special surface properties such as roughness, shape (contour) and similar measurement variables, the surface or surface regions to be measured is or are frequently probed mechanically. To this end, various probing bodies such as spheres, measuring prods, diamond tips and the like are employed, depending on the task. Whereas the mechanical measurement is usually effected through point-wise probing of the workpiece surface, for determining the surface roughness or the surface contour, or shaped elements of the workpiece, it is conventional practice to draw a probe tip, such as a diamond or steel tip, across a predetermined path at a predetermined speed, and record or evaluate the essentially perpendicular deflections of the probe tip from the workpiece surface. A prerequisite for this process is always the detection of the movement or deflection of the probe element. For this purpose, high-resolution, high-speed linear measuring systems (so-called displacement gauges) or related measuring systems are necessary. If the roughness measurement is to be combined with a contour measurement, or only a contour measurement is to be performed, the probe element generally traverses relatively large strokes during the measuring procedure. If possible, these strokes should fall within the measurement region of the corresponding measuring system.

Inductive measuring systems, for example, are known for measuring linear displacements. They typically emit a signal that is proportional to the deflection, and therefore must be analog measuring systems. So-called incremental transmitters are also known; these may operate according to optical principles. DE 197 12 622 A1, for example, describes an evaluation device for an optically probed scale division. The optical measuring system generates two signals S1, S2, which are supplied as probe-data signals to the evaluation unit. The probe-data signals are phase-shifted by 90° and periodic. The signals are conveyed via an analog-digital converter. The number of maxima passing through characterizes a step number, and the precise signal value defines the path traveled beyond the step number. The cited publication, however, does not address how the signals are obtained. Instead, it focuses on optical and magnetic scales, and therefore sensors.

DE 196 52 563 A1 discloses a photoelectric position-measurement system comprising a light source, a stationary diffraction grating, which acts as a beam splitter, and a moving diffraction grating. The first diffraction grating emits diffracted light beams of +1 and −1 orders. These light beams impact the moving diffraction grating, which reflects back the partial beams of +1 and −1 orders. The partial beams pass through the beam splitter again, and are brought to interference. The moving diffraction grating and the grating serving as a scale are thus impacted by light that has been dispersed into a plurality of partial beams and spread. only a portion of the spread light is recombined by the diffraction grating acting as a beam splitter, and brought to interference.

EP 0 586 454 B1 discloses a different measuring principle for measuring position. Here, a diffraction grating is illuminated with a parallel light bundle that is capable of interference. The back-scattered light bundles of −1 and +1 order are alternately brought to interference with one another by way of a beam splitter, and the interference patterns are evaluated by respective detectors.

The position of the scale is exclusively determined with the diffracted beams of +1 and −1 orders. These only carry a portion of the used light energy.

It is therefore the object of the invention to provide an optical position sensor that permits a good utilization of light.

This object is accomplished with a measuring device having the features of claim 1.

The measuring device according to the invention has a diffraction grating that is impacted by a light bundle that is capable of interference. The diffraction grating generates one undiffracted light beam, and a plurality of diffracted light beams. Of these, the diffracted light beam of +1 order and the diffracted light beam of −1 order, along with the undiffracted light beam (0 order), which has passed the diffraction grating, are used to generate an interference pattern. The beam maxima of the zero maximum, the plus one maxim and the minus one maximum overlap partially, so a bright interference pattern can be generated with the lowest output by the light source. Hence, very low-capacity laser diodes can be used to generate the interference-capable light bundle. This has the advantage of a very small introduction of heat into the entire measuring device, which in turn increases its precision. Errors due to thermal expansions or temperature increases can be reduced or precluded. The entire measuring system can be very compact. A thermal separation of the light source, the diffraction grating and the sensors is no longer an issue.

The measuring device permits a high resolution, which may be influenced by a change in the grating constant of the diffraction grating, and the distance between the light source and the diffraction grating, if a non-parallel, interference-capable light bundle is being processed. The light bundle emitted by the light source is preferably focused by a corresponding optical device (optics), and the diffraction grating is disposed near the focal point, or precisely in it. The diffraction grating is preferably oriented transversely to the light beam. The diffraction grating, however, need not necessarily be disposed precisely perpendicular to the light beam. Slight deviations from a right angle are only mildly problematic, or not at all. A rotation or pivoting of the optical diffraction grating and a movement of the grating in the direction of the optical axis are also of little consequence.

The light beams diffracted by the diffraction grating produce an interference pattern that is detected by the optical sensor arrangement. The optical sensor arrangement can comprise one or more light-sensitive elements. It registers the light/dark transitions of the interference pattern. In the simplest case, the degree of a relative shift of the diffraction grating can be determined by counting out the registered light/dark passages at the sensor element. If the measuring device is additionally intended to determine the direction of the relative shift, a plurality of sensor elements is preferably involved in evaluating the shift of the interference pattern. The sensor elements can be offset from one another by, for example, one-half the width of a diffracted light beam or one interference fringe, so one sensor or sensor group produces a cosine signal, while the other sensor or sensor group produces a sine signal. The sensors may be wider than one interference fringe. It is preferable to use four sensor elements that are disposed adjacently in series, and at which the light patch formed by the undiffracted light beam and the diffracted light beams of +1 and −1 order is incident. Three of the four sensor elements assume a length that matches the length of the light patch. The patch impacts the sensor elements approximately in the center; the two outer sensor elements are still illuminated, however. The measurement stroke can be selected to be very large, and is only dependent on the length of the diffraction grating. If only whole interference bands are counted, the resolution matches the grating line spacing. This permits high-precision measurements.

If the resolution is supposed to be higher than can be achieved merely by counting the interference bands passing a sensor element, an analog evaluation of the signals can additionally be performed. In this case, it is possible to capitalize on the fact that the light/dark transitions at the individual sensors are not abrupt, but sinusoidal or cosinusoidal. An evaluation of the current brightness can permit an interpolation of the shift between different interference bands.

The measuring device is preferably a component of a measuring apparatus for measuring, for example, contour or roughness. The measuring apparatus also includes a positioning device, such as a feed device, with which the probe element and, possibly, the measuring device, is or are moved across the surface of the workpiece.

Further details about advantageous embodiments of the invention are the subject of the dependent claims, the drawing or the description. The drawing illustrates an exemplary embodiment of the invention. Shown are in:

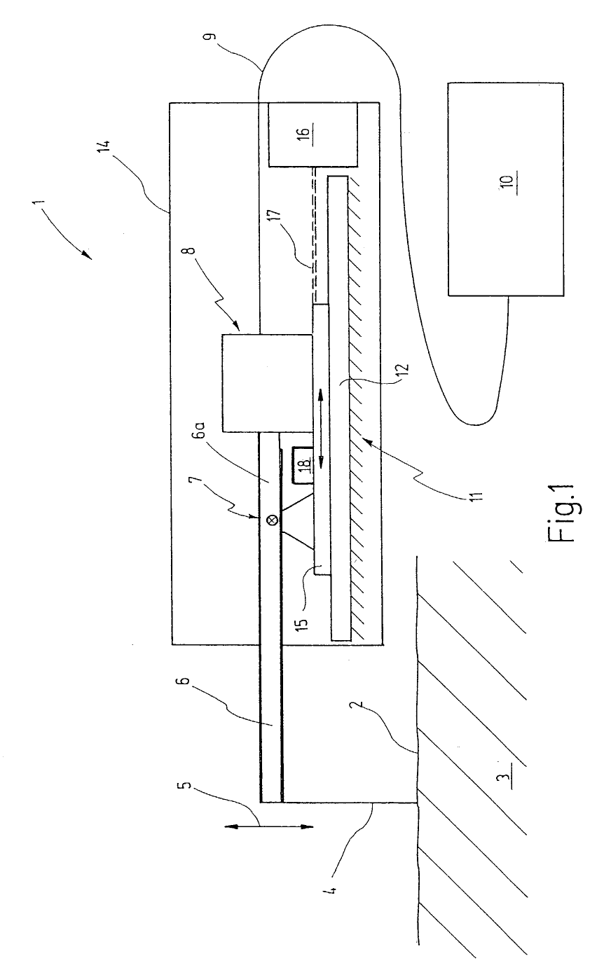

FIG. 1 a measuring apparatus having an optical measuring system at a workpiece, in a schematic, fundamental representation;

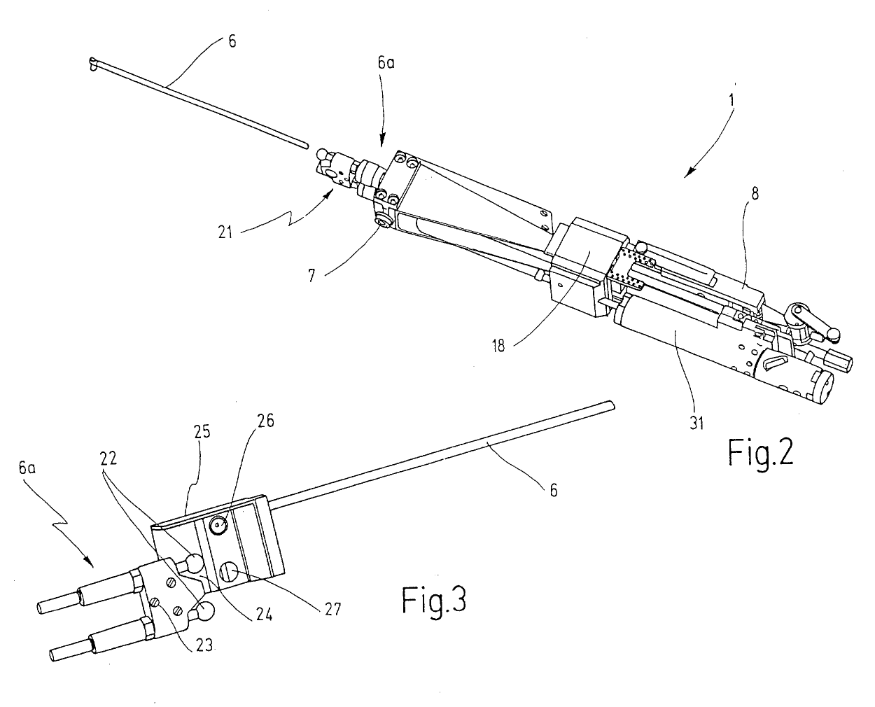

FIG. 2 the measuring apparatus according to FIG. 1, in a perspective view in its entirety and without the housing;

FIG. 3 the seating of the probe arm of the measuring apparatus according to FIG. 2, in a perspective, exploded representation;

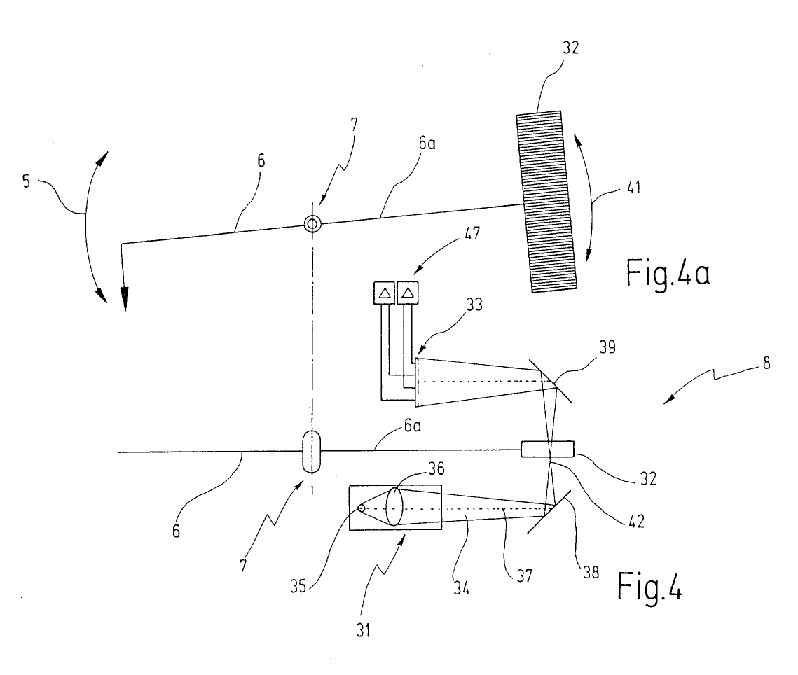

FIG. 4 the optical measuring system of the measuring apparatus according to FIGS. 1 and 2, in a schematic plan view;

FIG. 4a the probe arm and diffraction grating of the optical measuring system according to FIG. 4, in a schematic side view;

FIG. 5 the optical measuring system according to FIG. 4, in a functional representation; and

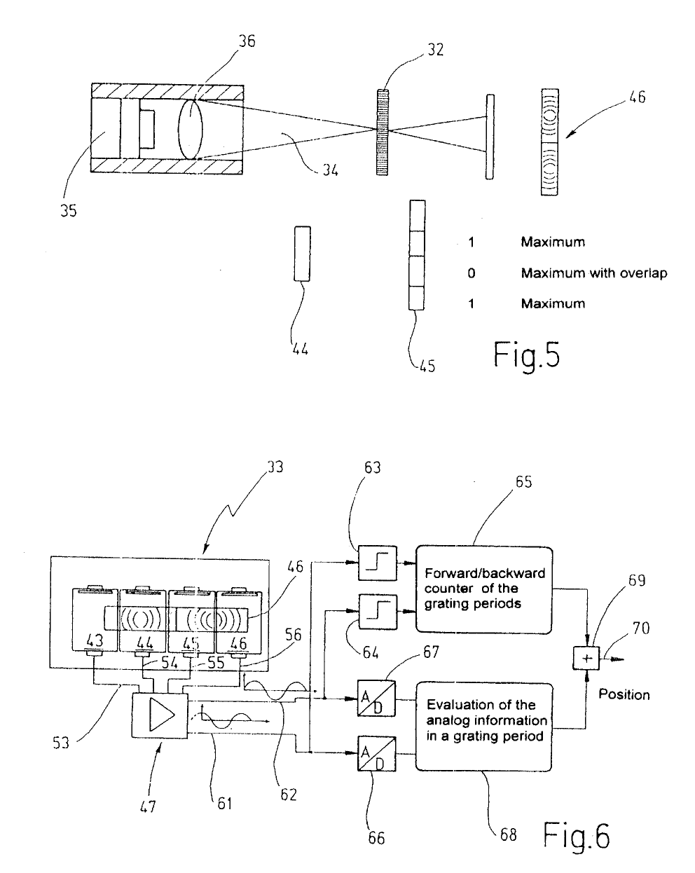

FIG. 6 a block diagram of an evaluation device of the measuring system.

FIG. 1 illustrates a measuring device 1, which serves in determining the profile or contour of a surface 2 of a workpiece 3. In addition, the roughness of the surface 2 can be determined. The measuring device 1 has a probe element 4, e.g., a probe tip, that is seated to move approximately perpendicular to the surface 2 of the workpiece 3 in a direction indicated by an arrow 5. A bearing device, formed in the present example by a pivotably seated probe arm 6, serves to move the probe tip. The probe arm 6 is held on a carrier 6a that is embodied as a two-armed lever and is suspended by suitable bearing means such as ball bearings, needle bearings, knife-edge bearings or springs in a pivot seating 7. It supports the probe element 4 at its one free end. At its other free end, the carrier 6a is connected to an optical measuring arrangement 8, which registers each pivoting of the probe arm 6 and therefore each movement of the probe element 4 in the direction of the arrow 5, and converts them into electrical signals. These signals travel via a line 9 to an evaluation device 10.

For the measuring device 1 to be able to ascertain the contour, and/or the roughness, of the surface 2 of the workpiece 3, the measuring device 1 includes a positioning device 11, which is designed to move the probe element 4 along a predetermined path across the workpiece surface 2. A guide rail 12 disposed in a housing 14 of the stationary measuring device 1 serves this purpose. A sliding member 15 is seated to be displaced on the guide rail 12, and supports the bearing 7 for the probe arm 6 and the optical measuring arrangement 8. The positioning device 11 further includes a control drive 16, which is connected by a gear element 17 to the sliding member 15 or an element connected to the sliding member 15. The gear element 17 may be, for example, a threaded spindle that can be set in rotation by the control drive 16. A nut seated on the threaded spindle may be connected to the sliding member 15, in which instance the nut is seated on the sliding member 15 so as to be fixed against axial rotation and displacement. Other linear drives, such as toothed belts, traction cables or wires, may also be used.

A lift drive 18, which can be activated as needed, acts on the end of the probe arm 6 that is connected to the optical measuring arrangement 8, for example by way of a mechanical coupling. This drive allows the probe arm 6 to be pivoted purposefully, for example for raising the probe element 4 from the workpiece surface 2. The lift drive 18 can also be used to exert a measurement force. In this case, the lift drive 18 may be embodied as a magnetic linear motor. As an alternative, spring mechanisms or similar devices may exert the measurement force.

Unlike in the embodiment shown in FIG. 1, the measuring device 1 can also be configured without a positioning device 11 and a control device 16. If this is the case, an external positioning apparatus, not shown in detail, may also be provided, thereby moving the entire measuring device 1 in the desired direction. This can be effected by a carrier that can be moved in a controlled manner in one or more directions, and supports the measuring device 1.

Whereas the measuring device 1 in FIG. 1 is shown in a relatively schematic representation, FIGS. 2 and 3 present a view of a measuring device 1 in a practical embodiment. Details and elements that are identical to the embodiment shown schematically in FIG. 1 are provided with the same reference characters. As shown in FIG. 3, the probe arm 6 is held, as a detachable probe-arm segment, to the carrier 6a, which is permanently mounted to the measuring device 1. A coupling device 21 represented as a magnetic probe-arm holder serves in seating the probe arm 6 on the carrier 6a. This device is shown separately in FIG. 3. Two spherical heads 22 and a magnet are associated with the carrier 6a; in FIG. 3, the magnet is disposed on the side of the carrier 6a facing away from the viewer. A locking screw 23 adjacent to the magnet has an end face with an associated, corresponding, planar bearing surface 24 on a holding part 25 of the probe arm 6. A conical recess 26 (90° incline), which is associated with one of the spherical heads 22. A prismatic recess 27 embodied in the holding part 25 is associated with the other spherical head 22, and serves in precisely positioning the probe arm 6 relative to the carrier 6a.

The embodiment of the optical measuring arrangement 8 represents a notable feature of the measuring device 1. This is shown schematically in FIGS. 4 and 4a. The measuring arrangement 8 includes a light source 31, a diffraction grating 32 and a sensor arrangement 33, and possibly further optical or mechanical elements. The light source 31 generates a preferably convergent beam 34 of interference-capable light. To this end, a laser diode 35 is provided, whose light is reshaped into a light bundle having the desired convergence (or divergence) by an objective, in the simplest case a collector lens 36. In the preferred embodiment, the light bundle 34 is created with convergence relative to an optical axis 37. To make the measuring arrangement 8 as compact as possible, one or more mirrors 38, 39 may be disposed in the beam path leading from the light source 31, through the diffraction grating 32 and to the sensor arrangement 33. If necessary, optical-guide elements or other light-transmitting devices may also be provided.

The diffraction grating 32,is connected directly to the part 6b serving as a pivot carrier, the part also supporting the probe-arm segment 6a, which constitutes the actual probe arm. The diffraction grating 32 may be a simple ruled grating whose light-diffracting grating lines are oriented parallel to one another and approximately transversely to the direction of movement of the diffraction grating 32, as represented by an arrow 41 in FIG. 4a. The individual grating lines can therefore be oriented approximately parallel to the probe arm 6, or parallel to its axis of rotation, depending on the direction in which the light bundle 34 is guided (transversely or parallel to the probe arm 6).

The grating lines of the diffraction grating can be disposed equidistantly or, if needed, with varying spacing. The grating spacing affects the resolution, and therefore the linearity, of the probe system. Varying grating spacing can serve to compensate linearity errors that would otherwise be present, or to generate a desired, nonlinear characteristic curve.

If need be, the grating lines can also be disposed at acute angles relative to one another, so the imaginary extensions of all grating lines meet in the axis of rotation of the bearing device 7 in the—somewhat modified—example depicted in FIG. 4a. The diffraction grating, which is preferably planar, can also be arched or curved. It is disposed near the focal point 42 of the converging light bundle 34, so only a few, for example three or five, grating lines are illuminated.

The light reflected by the diffraction grating 32, or allowed to pass through, as in the illustrated example, forms an interference light bundle 34a, which contains diffracted and undiffracted components that impact the sensor arrangement 33 as interfering light beams. The arrangement is, as shown in FIG. 6, preferably divided into a plurality of elements, such as four elements 43, 44, 45 and 46, which together form an optoelectrical converter (the sensor arrangement 33). The individual elements 43 through 46 of the sensor arrangement 33 are impacted by an interference pattern that arises in the portion of the interference light bundle 34a that has passed the diffraction grating. As indicated in FIG. 5, a first brightness maximum is present parallel to the optical axis, the maximum representing an undiffracted beam component. To the right and left (in FIG. 5, above and below) of the undiffracted beam are a +1 maximum and a −1 maximum, respectively. The light bar (bar-shaped light patch) 44, which is shown on the left in FIG. 5 and is generated by the laser diode 35 and the objective 36, is therefore spread through diffraction. The spread light patch, which is formed through the superposing of the 0 maximum with the +1 maximum and the −1 maximum, is thus larger than the light bar 44. It contains a pattern of interference bands, as indicated at 46 in FIG. 5. The lines characterize the position of the diffraction grating 32 relative to the light bundle 34 or its optical axis.

The diffraction grating 32 is disposed fairly close to the focus 42 or in it, so only relatively few lines of the ruled grating serving as the diffraction grating 32 effect the formation of the interference pattern. This pattern is incident onto the elements 43 through 46 of the sensor arrangement. The light bar 46 containing the interference pattern is preferably shorter than the sensor arrangement 33, so the outside sensor cells 43, 46 are only partially covered by the superposed light patch 46.

Each element 43, 44, 45, 46 is connected to a conduit of an analog amplifier 47. Corresponding inputs 53, 54, 55 and 56 are provided for this purpose, thereby forming a differential input in pairs (53 and 54; 55 and 56). Accordingly, a first output signal is generated at an output 61 from the signals present at the inputs 53, 54. An output 62 of the amplifier 47 emits the amplified differential signal of the inputs 55 and 56. Because the sensor cells 43, 44, 45 and 46 are arranged such that the sensor-cell pair 43, 44 is offset relative to the sensor-cell pair 45, 46 by one-half the width of an interference band, sine signals that are phase-shifted by 90° are present at the outputs 61, 62 of the amplifier 47. The signals of the outputs 61, 62 are forwarded to trigger stages 63, 64, which convert the sine signals into square-wave signals. A downstream forward/backward counter 65 receives the triggered sine and cosine signals, and counts them. The 90° phase shift between the sine signal and the cosine signal permits an unambiguous determination of direction, so the forward/backward counter 65 increases or decreases its counting number, corresponding to the direction of movement of the diffraction grating 32.

Analog/digital converter stages 66, 67 are switched in parallel to the trigger stages 63, 64. These converters convert the current signal value of the outputs 61, 62 into digital values. The digital values obtained in this manner are characteristic of the current brightness difference between the sensor cells 43, 44 and 45, 46, respectively. This information can be used to perform an interpolation of the angular position on the sine curve between a maximum and a minimum of the brightness or the signal value. The resolution can therefore be better than what is predetermined by the grating-line density of the diffraction grating 32. The analog/digital converter stages 66, 67 and a connected evaluation circuit 68 form an analog evaluation circuit for determining the angle between the brightness maximum and the brightness minimum.

The outputs of the forward/backward counter 65 and the evaluation circuit 68 connected to the analog/digital converters 67, 68 are connected to a combination stage 69 that adds the step numbers that are predetermined by the forward/backward counter stage 65 and the intermediate step value produced by the evaluation circuit 68 in order to obtain a measurement value. This value is sent to an output 70.

The measuring device 1 described to this point operates as follows:

If the surface 2 is to be measured by the measuring device, the probe arm 6,is guided with the probe element 4 across the surface 2 of the workpiece 3. For this purpose, the control device 16 is actuated in, for example, the measuring device according to FIG. 1. The probe element 4 follows the contour and the roughness of the surface 2, which causes the probe arm 6 to be deflected correspondingly. The movement of the probe arm 6 is transmitted onto the diffraction grating 32, which moves corresponding to the deflection of the probe element 4. The diffraction grating 32 is displaced relative to the light bundle 34 or its optical axis. Accordingly, the interference bands of the light patch 46 run across the sensor arrangement 33. Each interference band thereby generates a sine wave at the outputs 31, 32. The count contents of the forward/backward counter 65 reflect the number of interference bands that have passed through, as a function of their direction. The evaluation circuit 68 determines the intermediate values. The output of the combination stage 69 emits a position signal that precisely characterizes the current deflection of the probe element 4.

The proposed sensor employing interference optics can be used not only for one-dimensional measuring tasks, but also for two-dimensional ones, as needed. In this case, instead of one ruled grating, two ruled gratings that are offset from one another by 90° are used; they can be moved either together or independently of one another. In some cases, a point grating (raster) may also be used. The point grating can be formed by points arranged in a circle or another shape on a light-permeable or light-reflecting background. The inverse arrangement, in which the points are transparent or reflective and the remaining surface is opaque or non-reflective, may also be used. In this situation, a linear sensor is not used, as indicated in FIG. 6; instead, a surface sensor or two crossed linear sensors, which form an angle of, for example, 90° with one another, is or are used.

A measuring device that employs interference optics for detecting and tracking the movement of a mechanical element 4 has a light source 31 for emitting a light bundle that is capable of interference, a diffraction grating and a sensor arrangement 33. A beam path leads from the light source to the sensor arrangement 33 by way of the diffraction grating 32. The diffraction grating divides the light bundle into at least three partial components, thereby forming a light patch having three overlapping maxima, the center, zero maximum and the two minus one and plus one maxima on either side, at the optical sensor arrangement 33. The light beams for generating the three brightness maxima interfere with one another, so the resulting superposed light patch 46 contains interference bands that run in one direction or another when the diffraction grating is moved. The movement of the interference bands is detected with the sensor arrangement 33, and evaluated in an evaluation circuit. This permits a precise detection of each movement of the diffraction grating 32. The proposed arrangement utilizes virtually the entire interference pattern generated from the light emitted by the light source. This results in light-intensive interference patterns, even with low capacities of the light source 31. Thus, low-capacity components can be used.

1. A measuring device (1), particularly for measuring the surface roughness and/or the surface contour of a workpiece (3),
having a probe element (4), which is seated to move and can be brought into contact with the workpiece surface (2),
having a diffraction grating (32), which is seated to move and is connected to the probe element (4),
having a light source (31) for generating a light bundle (34) that is capable of interference and is aimed at the diffraction grating (32) for generating an interference light bundle (34a) having at least one zero maximum (0), a plus one maximum (+1) and a minus one maximum (−1), and
having an optical sensor arrangement (33), which is exposed to the interference light bundle (34a) originating from the diffraction grating (32).

2. The measuring device according to claim 1, characterized in that the optical sensor arrangement (33) is connected to a digital evaluation device (63, 64, 65) having at least one counter (65) for detecting the number of interference fringes that have passed the sensor arrangement (33).

3. The measuring device according to claim 1, characterized in that the sensor arrangement (33) is connected to an analog evaluation device (66, 67, 68) that forms an interpolation device, which is designed to allocate a position value to the brightness detected by the sensor arrangement (33).

4. The measuring device according to claim 1, characterized in that the sensor arrangement (33) has at least two sensor elements (43, 44, 45, 46), which serve in detecting the brightness at various areas of the interference light bundle.

5. The measuring device according to claim 1, characterized in that the sensor arrangement (33) includes two sensor groups (43, 44; 45, 46), each comprising at least one sensor (43, 44; 45, 46) and being offset from one another by one-half the interference-fringe width.

6. The measuring device according to claim 1, characterized in that the probe element (4) is seated to move one-dimensionally.

7. The measuring device according to claim 1, characterized in that the diffraction grating (32) is permeable for light.

8. The measuring device according to claim 1, characterized in that the diffraction grating (32) is seated to move transversely to the light bundle (34).

9. The measuring device according to claim 1, characterized in that it includes a positioning device (16) that is designed to move the probe element (4) across the workpiece surface in a predetermined direction.

10. The measuring device according to claim 1, characterized in that it includes a force-generating device (18) for generating a measurement force.
